(19) United States
(12) Patent Application Publication
(10) Pub. No.: US 2003/0028599 A1
(43) Pub. Date: Feb. 6, 2003

(54) Method and system for a communication scheme over heterogeneous networks

(76) Inventor: Amir D. Kolsky, Binyamina (IL)

Correspondence Address: KENYON & KENYON, ONE BROADWAY, NEW YORK, NY, 10004, US

(21) Appl. No.: 09/885,669

(22) Filed: Jun. 19, 2001

(51) Int. Cl. G06F 15/16

(52) U.S. Cl. 709/206; 709/228; 709/245

(57) ABSTRACT

A method and system for a communication scheme between a plurality of applications over heterogeneous networks. The method and system include sending an alias identifier via a first application, an alias mechanism resolves and/or translated the alias identifier using a data storage medium. The data storage medium can be accessed via a management interface. The alias identifier is associated with a command and an application layer address. The alias mechanism then can execute the command to provide a communication arrangement. Access to the data storage medium could further require an access code from an entity, user, device and/or application.

### FIELD OF THE INVENTION

The present invention relates to a method and system for use in communication networks in which an entity may contact another entity over heterogeneous networks via an alias identifier, the entity being a person, application or device.

### BACKGROUND INFORMATION

Existing communication networks can be defined and described in a stack model. A network stack is used to separate the network into a series of layers, each with its own responsibility. Each layer of the network stack can have its own hardware/software components. In FIG. 1, for example, in the OSI (Open Systems Interconnection) network stack, the layers are physical layer 1, link layer 2, network layer 3, transport layer 4, session layer 5, presentation layer 6, and application layer 7. A management plane 10, or M-plane, can be associated with the network stack. Any protocol stack on a host must work in tandem with an identical protocol stack on another host. In such cases, a message is sent between like layers in the respective stack by sending it all the way down to the lowest layer, across to the other stack's lowest layer and back up to the like layer, also called a peer layer. The message must be encoded according to the like layers' rules for a transfer between the like layers to be effected. When an encoded message is received by a layer, it is then decoded according to that layer's rules. Such encoding can be effected by a transformation on the message and associated information often called encapsulation or packaging.

In FIG. 2, a message sent via an application layer 7 is transferred to presentation layer 6, then to session layer 5, then to transport layer 4, then to network layer 3, then to link layer 2, and then to physical layer 1. The message is physically transmitted from physical layer 1 to physical layer 101 via a connection 11. The message then is transferred from physical layer 101 to link layer 102, to network layer 103, to transport layer 104, to session layer 105, to presentation layer 106, to application layer 107. Further, a management plane 100 can be associated with the network stacks such that the transfer and encoding/decoding are effected by management operations.

FIG. 3 shows a message as it is encapsulated from the (N+1)^{th} layer 201 to the N^{th} layer 202 to the (N−1)^{th} layer 203 to the (N−2)^{th} layer 204. As the message moves down the stack layers, a transformation is applied to it which in this example is the application of a prefix and/or a suffix containing information that will enable the correct delivery of the message to the corresponding peer layer. This information may include addressing information, packaging information such as length or CRC (Cyclic Redundancy Check, i.e., method establishing data was correctly received), encoding information, content negotiation information and so forth.

Such transfer of a message between layers is performed by correct addressing of the intended recipient layer. For this addressing to work, the higher-level address must be bound to address of the layer beneath it. For example, an IP (Internet Protocol) address can be bound to an Ethernet adapter MAC (Media-Access Control) address. Addresses are bound to other lower-level addresses by the lower stack layer, which could be implemented in hardware or software. Multiple addresses may be bound to a single lower layer addresses. For example, multiple IP addresses can be bound by an Ethernet adapter to a single MAC address.

FIG. 4 shows the addressing of a message moving between peer layers. An address A_{N′} is bound by layer N 208 to address A_{(N-1)′}. When layer N 205 wants to communicate with its peer layer N′ 207, and knowing the address A_{N′} of layer N′ 207, layer N 205 employs its lower layer (N−1) 206 to effect the delivery. Since A_{N′} is bound to A_{(N-1)′}, layer N 205 can resolve the address A_{N′} to a layer (N−1)′ 208 address A_{(N-1)′}. Since Layer (N−1)′ 208 is the one binding A_{N′} to A_{(N-1)′} it is able to deliver the message to the appropriate layer 207 component that is addressed by A_{N′}.

FIG. 4, if layer N 205 addresses a peer layer N′ 207, where peer layer N′ 207 is a part of a different stack, then a host, e.g., a computer, must be used as an intermediary to reconcile the differences between different stacks. The intermediary may be a variety of different applications, depending upon the layer addressed. A layer 1 intermediary is called a hub or switch; layer 2 is called a bridge; layer 3 is called a router or gateway; etc. Each intermediary has at least two separate stacks up to and including the interconnecting layer. For example, a router at layer 3 has two stacks up to and including layer 3 and the routing is performed in layer 4 and/or above.

Above the application layer, in a network stack is an entity which can be regarded as the comprising the Entity layer. Entities generally communicate messages through an applicative protocol stack using a manual user interface such as an email client, a web browser, a telephone handset, a pager or an interactive voice response system—in the case of a human entity, or by some automated interface—usually an application programming interface (API) in the case of an automated entity. The entity can communicate with another entity through the application layer, providing an application layer address to facilitate the message transfer to the entity. The application layer address can be, for example, a telephone number, an email address, a pager address, ICQ (“I Seek You”—a program allowing, among other things, one to contact and chat with others online on the internet in real time) number, and an internet messenger identification. The entity may be a person, application or device. An entity's identity is effectively the entity layer address. When a first entity wants to initiate communication with a second entity, the first entity needs to provide an application, e.g., a telephone, with an appropriate application layer address, e.g., the telephone number that needs to be used to communicate with that second entity via a particular application. If the second entity is no longer associated with the application that the application layer address maps to, then a connection cannot be established communication with the second entity can not be effected. Effectively, the entity's identity, which is the entity layer address, is bound to the application, or application layer.

### SUMMARY OF THE INVENTION

The present invention provides for a method and/or system for a communication scheme for one or more applications over heterogeneous and homogeneous networks by providing for an alias layer located just above the application layer and just below the effective entity layer. The present invention further provides for an effective separation of an entity's identity from a specific application in the application layer.

The present invention further provides for a method and/or system for a communication scheme for one or more applications over heterogeneous and homogeneous networks involving entering an alias identifier through a first application to an alias mechanism in an attempt to contact a second application. The alias identifier can be in the form of various available formats including a tone, a voice statement, and a character sequence.

The alias mechanism accesses a data storage medium, which may be located within the alias mechanism or outside of the alias mechanism. The data storage medium could be a variety of things including a software program disposed on an external source such as a computer, a database, or a data store. The data storage medium can be modified, updated, deleted, created by external sources including any entities or applications associated with the alias identifiers. Further, the data storage medium can be updated manually or automatically, e.g., via a software program or a person. For example, an entity can access the data storage medium with the alias identifier via the alias mechanism and the management interface. By entering an appropriate access code, and possibly by answering a few additional questions by the system, the entity can automatically update the data storage medium for that alias identifier to contain its email address (which it is currently in communication with) in place of its telephone number.

In embodiments of the present invention, an entry in a data storage medium can involve an association of an alias identifier with at least one command, where the command may reference an application layer address. When an alias identifier is presented for inquiry, the data storage medium can compare for a match between the inquiry and those alias identifiers stored and once matched, the information associated with that alias identifier in the data storage medium is retrieved and then executed by the alias mechanism. The information can include a command and an application. An example of a command to the PSTN application can be to establish a telephone call with a specific phone number. Examples of applications and their corresponding application layer addresses include the PSTN, voice mail or conferencing applications with a telephone number address, TCP/IP (Transmission Control Protocol/Internet Protocol) email with an email address, a pager network with a pager address and any other available addresses.

In embodiments of the present invention access to the data storage medium and/or alias mechanism can be controlled by associating permissions, authentications and encryptions with the alias addresses which specify which entities may use that alias address, update information associated with it and control its lifecycle including how strong the authentication must be, what the authenticated entity is authorized to do and any special communication circumstances, such as encryption, that need to be applied to the communication session. Examples of external authentication data include, but are not limited to, a tone code, a certificate, a smart card, a voice signature, a personal identification number (PIN), a password, and a biometrics-based identification. The biometrics-based identification can include: a handprint; fingerprint; thumbprint; retina; skin sample; hair sample; body fluid sample such as blood, tears, and saliva; facial scan; dental scan or sample; and the like. Other authentication may be internal and may rely on originating application addresses or other lower level stack addresses. For example, a specific originating phone number and application layer address may be associated with an alias address so that all attempts to use that alias layer address will always succeed, and/or attempts from other places will require PIN verification. More than one authentication scheme and data may be associated with the use of an alias address, and different operations associated with an alias address may require different types of authentication.

In further embodiments, once an application layer address is associated with an alias identifier, e.g., association being made when the application is used to contact the alias switching service and/or alias device based on the alias identifier and a PIN (personal identification number) or other means of authentication such as those mentioned herein or those otherwise available, an entity need not enter the PIN on subsequent events when using the same application and the same alias identifier.

The alias mechanism can be an alias device and/or an alias switching service system. In an embodiment of the present invention where there are at least one alias device and at least one alias switching service, the alias device may be used to first receive the alias identifier from an entity.

In embodiments of the present invention, an entity could be, but is not limited to, a robot, a device, a person, an application and/or a computer.

In embodiments of the present invention, an alias device can accept the alias identifier entered, attempt to resolve the alias identifier via an internal or external data storage medium, and then connect two or more entities through two or more applications. The alias device does not necessarily need to use an alias switching network, e.g., in the case where the alias identifier is resolved by the alias device and the communication is over homogenous networks supported by the alias device and hence require no intermediary.

Embodiments of the present invention provides for at least the following situations: i) the alias identifier is invalid; ii) the alias identifier is valid, the destination application address is known, and there is access for the user to a like application; iii) the alias identifier is valid, the destination application address is known, but there is no access for the user to a like application; iv) the alias identifier is valid, the destination application address is not known, but there is access for the user to a like application; and v) the alias identifier is valid, but the destination application address is not known and there is no access for a like application.

In embodiments of the present invention, the alias device can at any point transfer the alias identifier with or without any information resolved from the data storage medium to the alias switching network for resolution, translation and switching.

In the event that the alias device cannot resolve the alias identifier, i.e., the alias identifier is invalid, then the alias device can forward the alias identifier to the alias switching service for resolution and/or indicate an error to the application or user. In the event that the alias device is unable to connect to a destination application because of differing networks or the destination address is not known, the alias device can forward the alias identifier to the alias switching service for resolution, translation and/or executing the commands or connections involved or may communicate with some other facility that is capable of such operations.

In embodiments of the present invention, the alias switching service can resolve, translate and effect connections and other commands based on the alias identifier. The alias switching service, similar to the alias device, can access a data storage medium to associate an alias identifier with an application or application identity, a command and an application layer address. The alias switching service can execute the commands and complete connections between two or more applications operated by two or more entities. The alias switching service further can translate a message or otherwise from a sending application into a form appropriate for the destination application. For example, if an entity A attempts to communicate with an entity B via alias identifier X over a pager network, by using a pager application, and the alias identifier X entry in the data storage medium indicates that it is associated with an email application with a specific email address, i.e., entity B is only reachable by email, then the alias switching service can translate that pager message from entity A and send it via email to entity B via the appropriate network stack(s).

At any point of non-resolution or non-connection, the alias mechanism can be configured to indicate such error via an indication to any involved entities, for example, using a light, visual message or oral message.

In embodiments of the present invention, the applications involved in the communication scheme can be, including, but not limited to a pager, an access terminal, a computer, a telephony device, supplementary telephony services, an error message, an interactive voice response proxy, a facsimile, a video conferencing device, a internet meeting device, an interactive television, an external device, a signal switching point, a PDA, SMS, and an application.

In embodiments of the present invention, the alias mechanism can be used to effect, depending on the command and destination application layer address associated with the alias identifier, at least one of a conference call communication, a bi-directional call communication, a multiparty call communication, a person to person call communication, a telephony (e.g., PSTN (Public Switched Telephone Network), ISDN (Integrated Services Digital Network), PLMN (Public Land Mobile Network) and/or IP (Internet Protocol) Telephony) communication, a facsimile transmission, a pager communication, a message machine, a voicemail, an instant messaging service and an email communication.

In embodiments of the present invention, an information or command associated with an alias identifier can instruct that none, some or all entities identified by the alias identifier can establish a connection until all or some entities have been authenticated. Authentication, as described herein, can occur in a variety of ways including via an application layer address associated with the alias identifier and/or an access code. In an exemplary embodiment, multiple authentications can be allowed for the same user which means that the user can have multiple ways for identification.

In embodiments of the present invention, the alias identifier can be associated with one or more commands and application layer addresses. Further, an application layer address can be bound to one or more alias identifiers.

In embodiments of the present invention, an alias switching service and/or device can be used to invoke one or more applications, the application can, for example, perform alerts, e.g., a one-way application to alert at least one other application using a sound or message. In further embodiments of the present invention, an alias switching service and/or device can invoke an application which effects a distribution list containing multiple application layer addresses or alias identifiers so that the multiple addresses are contacted as appropriate.

In an exemplary embodiment, in a point-to-point connection between two entities, a first entity and a second entity both enter the same alias identifier into an application. However, the first and second entities each may authenticate differently and are identified by the alias device and/or the alias switching service differently, e.g., with a different PIN and/or different application layer address. An association may be formed between a first authenticated entity, the alias identifier and an application layer address. This association must be formed for a second authenticated entity to use the alias to communicate with the first entity. In further embodiments of the present invention, the alias must be input into the application using that application's conventions either manually or by some input device such as a barcode reader, scanner, infra-red communications, RF (Radio Frequency) communications, etc. In all cases, the information entered is a function of the application and the alias identifier. For example, an alias identifier D can be entered on a phone by dialing “##D”, in a web browser by entering “aliasid://D” or sending an email message to “D@somealiasidhost”.

The present invention further provides a system and method for a communication scheme between a plurality of applications over heterogeneous networks, including sending a plurality of alias identifiers via a plurality of applications; receiving the plurality of alias identifiers by an alias mechanism; and managing the plurality of alias identifiers via the alias mechanism. Each alias identifier of the plurality of alias identifiers can be associated with at least one command, at least one application and at least one application layer address. Each alias identifier of the plurality of alias identifiers, the at least one command, the at least one application and the at least one application layer address can be stored in a data storage medium. Further, at least one of the following also can be effected: i) the alias mechanism authenticates each alias identifier of the plurality of alias identifiers via the data storage medium, and ii) the alias mechanism executes the at least one command associated with each alias identifier of the plurality of alias identifiers. Each alias identifier of the plurality of alias identifiers can be managed via the alias mechanism by a single entity or a plurality of entities so that the single entity or plurality of entities determines the at least one command, the at least one application and the at least one application layer address associated with each alias identifier of the plurality of alias identifiers.

The present invention further provides a system and method for a communication scheme between a plurality of applications over heterogeneous networks, including sending a first alias identifier via a first application; receiving the first alias identifier by an alias mechanism; sending a second identifier via a second application; and receiving the second alias identifier by the alias mechanism. The first alias identifier can be associated with a first command, a first application identity and a first application layer address, and wherein the first alias identifier, the first command, the first application identity, and the first application layer address are stored in a data storage medium. The second alias identifier can be associated with a second command, a second application identity and a second application layer address. The second alias identifier, the second command, the second application identity, and the second application layer address can be stored in the data storage medium. Further, at least one of the following also can be effected: i) the alias mechanism authenticates the first alias identifier via the data storage medium, ii) the alias mechanism executes the first command associated with the first alias identifier, iii) the alias mechanism authenticates the second alias identifier via the data storage medium, iv) the alias mechanism executes the second command associated with the first alias identifier, and v) the alias mechanism effects the first and second commands after the first and second alias identifiers are received and authenticated by the alias mechanism.

The present invention further provides a system and method for a communication scheme between a plurality of applications over heterogeneous networks, including sending a first alias identifier and a first access mechanism via a first application; receiving the first alias identifier and the first access mechanism by an alias mechanism; sending the first identifier and a second access mechanism via a second application; and receiving the first alias identifier and the second access mechanism by the alias mechanism. The first alias identifier and the first access mechanism can be associated with a first command, a first application identity and a first application layer address. The first alias identifier, the first access mechanism, the first command, the first application identity, and the first application layer address can be stored in a data storage medium. The first alias identifier and the second access mechanism can be associated with a second command, a second application identity and a second application layer address. The first alias identifier and the second access mechanism, the second command, the second application identity, and the second application layer address can be stored in the data storage medium. Further, at least one of the following also can be effected: i) the alias mechanism authenticates the first alias identifier and the first access mechanism via the data storage medium, ii) the alias mechanism executes the first command associated with the first alias identifier, iii) the alias mechanism authenticates the first alias identifier and the second access mechanism via the data storage medium, iv) the alias mechanism executes the second command associated with the first alias identifier and the second access mechanism, and v) the alias mechanism effects the first and second commands after the first identifier and the first and second access mechanisms are received and authenticated by the alias mechanism.

Any embodiments of the present invention mentioned herein can be used in combination with any other embodiments of the present invention mentioned herein.

### BRIEF DESCRIPTION OF THE DRAWINGS

FIG. 1 shows an available exemplary OSI network stack protocol.

FIG. 2 shows message flow between like communication stacks.

FIG. 3 shows an exemplary encapsulation of a message as it moves through layers in a network stack.

FIG. 4 shows an addressing of a message communicated between two stacks.

FIG. 5 shows an exemplary alias layer according to an embodiment of the present invention.

FIG. 6 shows communication via an exemplary alias layer according to an embodiment of the present invention.

FIG. 7 shows an exemplary alias switching service according to an embodiment of the present invention.

FIG. 8 shows communication via an exemplary alias switching service according to an embodiment of the present invention.

FIG. 9 shows an exemplary alias device and alias switching system according to an embodiment of the present invention.

### DETAILED DESCRIPTION

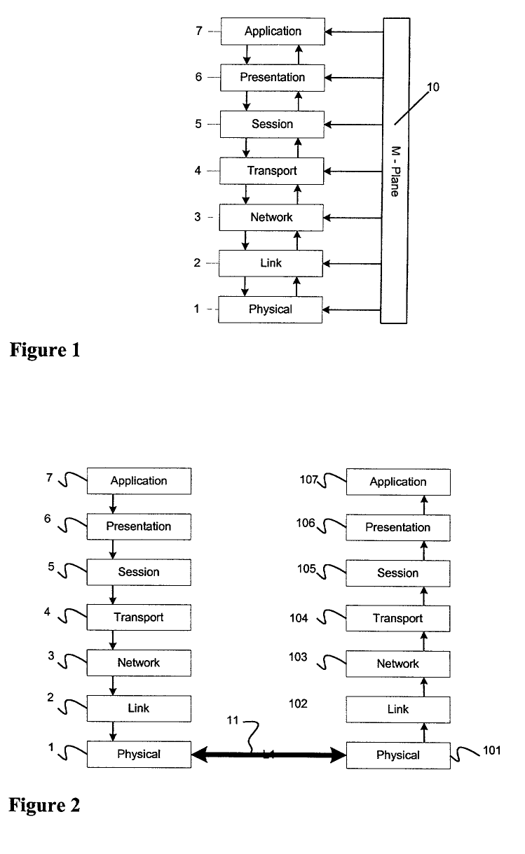

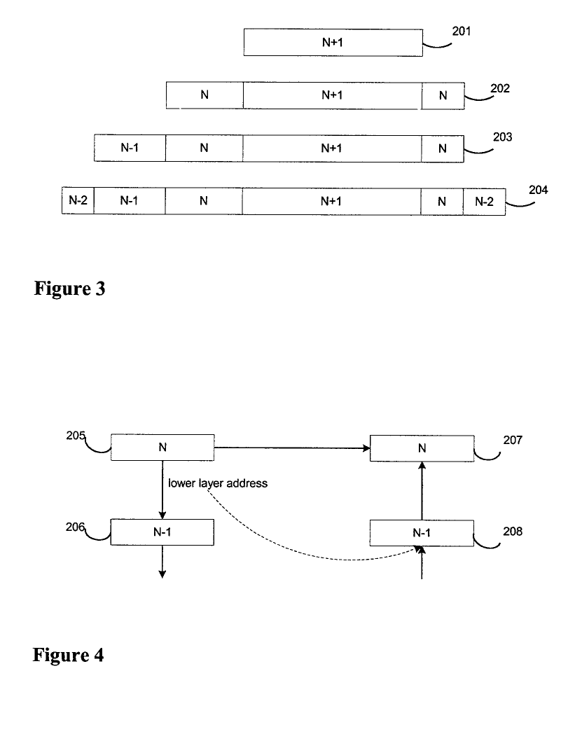

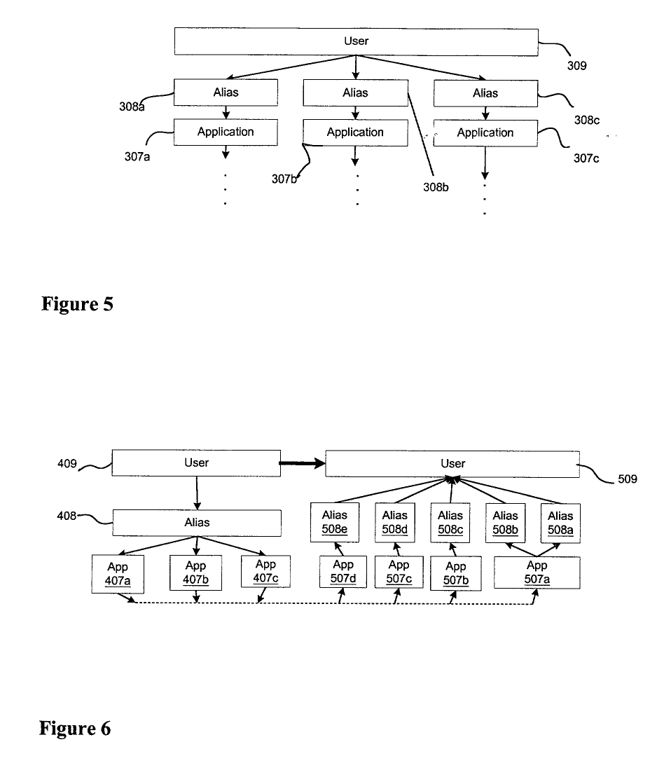

FIG. 5 shows an exemplary embodiment according to the present invention where an entity layer 309 lies above the alias layer 308 which lies above the application layer 307. The remainder of the layers is as detailed in FIG. 1. Since a layer communicating with its lower layer needs to provide the lower layer's address, with the new alias layer added, an entity must now provide an alias layer address or alias address, which binds to the other entity's identity, or entity layer address. The alias address is then resolved to an application address by the alias layer. Multiple alias addresses can be mapped to a single application address. The alias address is bound to an application address through a management interface.

FIG. 6 shows an exemplary embodiment according to the present invention where an entity may use multiple applications. Entity 409 can communicate a message to entity 509 by addressing it to an alias identifier (or alias address), via the alias layer 408, and delivering it using one or more applications 407a,b,c. Entity 509 can receive the message through one of a multitude of application resources with application layer addresses 507a,b,c,d to which the alias identifier is bound, via an alias layer 508a,b,c,d,e. Several alias addresses may be bound to one application address. The alias identifier can be bound to different application layer addresses at different times. Several alias addresses may be associated with one entity as this association is not necessarily a formal binding but can be a conceptual binding. Thus, an entity can be reached and reach others via multiple alias addresses. If the application used to send the message is not the same as the one used to receive it translation will have to take place between the formats of these applications.

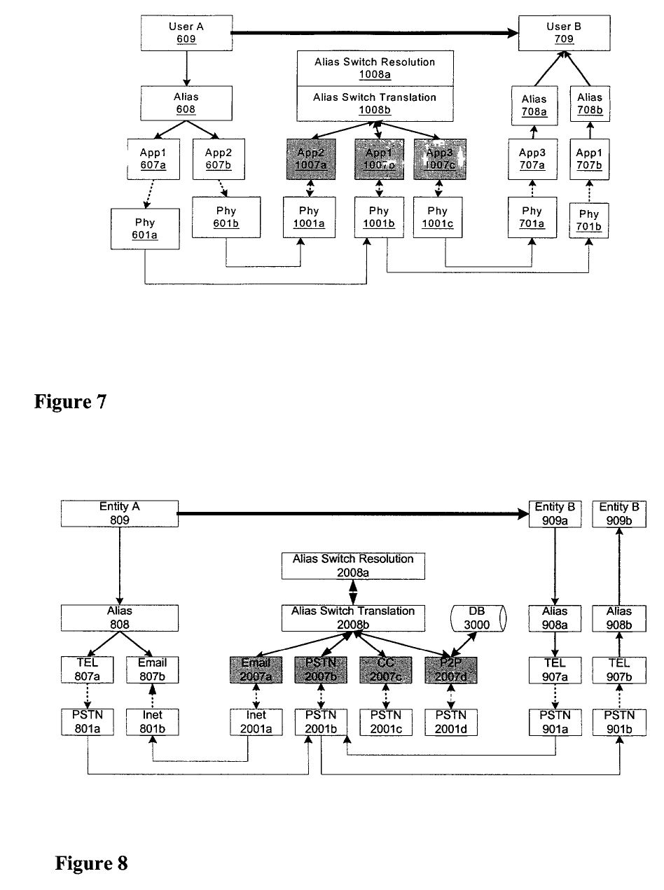

FIG. 7 shows an exemplary embodiment according to the present invention where an alias switch 1008a,b may be implemented. Entity A 609 intends to communicate with entity B 709, and selects through alias layer 608 the appropriate application 607a,b to perform the communication. In order to initiate the communication entity A must provide the alias layer with an alias layer address or alias identifier for entity B. Alias layer 608 may be real, comprising some hardware or software capable of formatting the message according to the application's rule, or it may be virtual, where the entity providing the alias identifier inputs it in a format suitable for the application. For example, if the alias identifier is “12345” and the application selected is a telephony application, then a real alias layer would accept “12345” from the entity and transmit it as “##12345” to the telephony application. A virtual alias layer serves as a reminder to the entity of the transformation that should occur, so the entity would enter “##12345” directly onto the telephony application. For example, if the application is an email application, the entity would enter “12345” into a real alias layer, which would transform the alias identifier into “12345@aliasserverhost” and would invoke an email application with “12345@aliasserverhost” as the destination address. For example, if the alias layer is virtual, the entity would have to invoke the email application on its own and specify “12345@aliasserverhost” as the destination address.

In an embodiment of the present invention, if the alias layer is not capable of resolving the alias identifier to the binding appropriate for entity B, the alias identifier is sent to the alias switch to perform this resolution on its behalf. The message with the alias identifier can be transformed in such a way that the original message and alias identifier are preserved in a message which is sent to the alias switch. For example, in the telephony case, “##12345” preserves the message, which is a connection request, and the alias identifier “12345”. The PSTN, for example, uses the prefix ## to route the connection request to the alias switch PSTN stack, which receives the dialed number “##12345” and retrieves the alias identifier “12345” from it. In the email case, the body of the email is the message to be delivered, the alias identifier “12345” is preserved by including it in the email destination address “12345@aliasserverhost”. The internet protocols can resolve “aliasserverhost” to the IP address of the SMTP server IP stack, and forward it up to the SMTP server stack. The SMTP server at the alias switch can retrieve the mailbox name “12345” from the email address. The mailbox name is in fact the alias identifier. Such packaging mechanisms exist for every communication application stack.

Thus, if application 607a is the selected application, the message and alias identifier are packaged according to the rules of application 607a and addressed and sent to the application address associated with application 1007b. The alias switch retrieves and saves the message, and retrieves and sends the alias identifier to the alias switch resolution 1008a.

If the alias identifier is invalid, the alias switch generates a message and returns it through entity A's stack. For example, the returned message may be an error message or tone on the phone, or a failure reply email message.

If the alias identifier is mapped to the same application as the one used to send the message to the alias server, i.e., application App1 1007b, then depending on the configuration of the alias either the message is sent to entity B via application App1 707b directly from the alias switch, or application App1 1007b instructs application App1 607a to communicate directly or indirectly with application App1 707b without the switch server intervention. This means that the alias switch can serve for the resolution processes solely or engage as an intermediary party in the actual communication.

For example, in the PSTN case, the alias switch can have conferencing capabilities, in which case when the alias identifier is resolved to a phone number, it will initiate a call with entity B and if connected will accept the call from entity A and connect the two calls in a conference. On the other hand, if, for example, the alias switch is an SS7 STP (Signaling System 7 Signal Transfer Point), the alias switch can have call redirecting capabilities, in which case the alias switch can instruct the application (the PSTN) to connect entity A to entity B directly.

For example, according to the present invention, in an email case, being a one-way, one-time communication, the correct email addressed (“entityB@entitybemailhost”) can be substituted for an alias switch address (“12345@aliasswitchhost”) and the email is sent to entity B.

For example, according to the present invention, in the case of a web address, the alias switch can open an HTTP connection with entity B's HTTP server and act as an HTTP proxy towards entity A or it may send entity A's web browser a redirect message with the URL that the alias id was resolved to.

If the alias identifier is resolved to a different application that a translation process must take place, direct communications cannot be effected. In this case it is either the alias switch that will perform the translation, assuming the appropriate translation plug-ins are available, or an external translation service will be used by redirecting application App1 607b to it. For example, when the alias switch resolution determined that application App3 1007c needs to be used to communicate with entity B, it must have the application App1-application App3 translator available if it is to act as a gateway between the two applications.

For example, according to the present invention, if entity A uses a phone and the alias identifier maps to an email message then the phone to email translator may prompt entity A to leave a message, record it as a file and send this file to entity B as an email message. Alternatively, it may employ a speech to text translator and turn the recorded message to text.

The alias layer 608, 708a,b are almost completely virtual layers. Thus, there is no need to provide the layer on any device. Instead, in such an embodiment of the present invention, the alias identifier needs to be entered as an alias address through an application or device, 607a,b, 707a,b. For example, if the alias identifier is 12345, a user A may dial, for example, **12345 on a telephony device, send an SMS (Short Message Service) message to, for example, **12345, send an email message to 12345@aliasswitch.com, send a pager message to 12345@pager.aliasswitch.com, or dial 1-800-GOALIAS and enter 12345 in response to an IVR (Interactive Voice Response) prompt. Other such examples using the various communication mediums available can be readily envisioned.

FIG. 8 shows another exemplary embodiment of the present invention. In FIG. 8, an entity A 809 wants to contact entity B 909a,b. Entity A may use telephone application 807a or email application 807b. Entity B however has two telephone applications 907a,b available and no email application. Entity A can select either of its communication stacks to contact entity B and should provide the alias identifier to these applications as discussed above.

The actions performed by the alias switch depend on the mapping of the alias identifier to the application as determined by the alias switch resolution and the application used by entity A. If Entity A used the telephone 807a, then the following can be effected:

The alias identifier maps to the PSTN with the telephone number bound to application 907b. The alias switch instructs the PSTN to connect 807a to 907b.

The alias identifier maps to a Conference Call facility—The call is connected to the CC server 2007c, with or without entity A's consent. Entity B may dial the same alias identifier and be connected to the same conference.

The alias identifier maps to a Person-to-Person (P2P) server 2007d. The first time entity B uses a new phone, say 907a, is used to dial the alias identifier it is associated, after authentication, to one end point of the person-to-person connection. The first time entity A uses telephone 807a to dial the same alias id it will be associated, after authentication, with the other endpoint of the person-to-person connection. Hitherto, whenever either entity now dials the alias identifier, the telephone used to dial the number will be determined and the call will be connected to the other telephone. If entity B attempts to dial the alias identifier on a different telephone 907b, entity B will be asked to authenticate and upon successful authentication will be connected to entity A. Entity B will have the option of associating its endpoint of the person-to-person connection with the new telephone number. Note that the P2P server 2007d maintains its own database 3000 which is distinct from the one used for alias resolution. The alias in this case is not resolved to a telephone number on the PSTN, but rather to a P2P link identifier which is operated with the aid of database 3000 by the P2P application 2007d.

If entity A uses email 807b, then the following may be effected:

The alias identifier maps to the PSTN with the telephone number bound to application 907b—Assuming an appropriate email to voice translator is installed, the alias switch will connect to the phone 907b and play the transformed email. If not, an “unknown address” error message will be returned. If entity B desires, the email reply could specify that entity B would rather be contacted by phone. This preference could be maintained as part of the information in the alias resolution database.

The alias identifier maps to a Conference Call facility—Several options here, for example: the email is transformed to voice and played to the participants of the conference or an error reply is returned to entity A if the appropriate translator is not available or successful.

The alias identifier maps to a person-to-person call as discussed above except that this changes the mapping of the entity A's endpoint from phone to email. Subsequent calls by entity A will be transformed to email, if possible, and sent to entity A as such.

If entity B does not support the email application, then the alias identifier will not be resolved to the email application. The alias identifier will not be resolved unless an appropriate alias translator can successfully effect the translation needed for the connection.

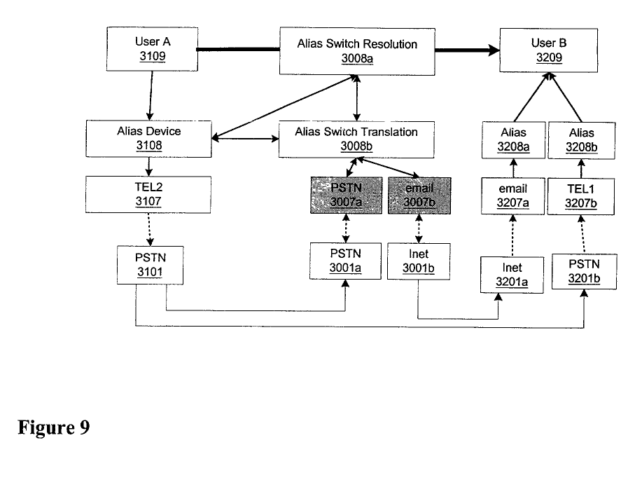

FIG. 9 shows an exemplary alias device 3108 and alias switching service 3008a,b of the present invention. User A 3109 enters an alias identifier via an alias device 3108 which may be software or hardware and associated with an application 3107. User A 3109 and user B 3209 may be at least one of a human, application, device, robot, an entity and computer. The alias device 3108 can check the alias identifier and if no match is found, the alias device 3108 can forward on the alias identifier to the alias switching service 3008a,b. If the alias switching service 3008a,b does not recognize the alias identifier and thus that the alias identifier is invalid, then no communication is activated. Or, in the alternative, the alias switching service 3008a,b may activate a connection to an application, such as a message machine, which informs user A 3109 that the alias identifier is invalid.

Alternatively, the alias device 3108 can check the alias identifier and a match may be found in its associated storage medium. In this case, the alias device 3108 may then check the information and command associated with the alias identifier match in the storage medium to determine whether an endpoint application can be known and/or can be found reachable. The information includes an application layer address. If the alias device 3108 resolves the alias identifier as being bound to an endpoint application address and the endpoint application is reachable, i.e., user A 3109 is using a telephone 3107 having a PSTN telephony network connection 3101 and the endpoint application 3207b is also a telephone operating on a PSTN telephony network connection 3201b, then the alias device effects the connection and user A 3109 reaches user B 3209 via alias layer 3208b without utilizing the alias switching service 3008a,b. If the alias device 3108 does not have the endpoint application address 3207a and/or does not find that the endpoint application 3207a is reachable because it is not a telephone but instead an email application, then the alias device 3108 can use the alias switching service 3008a,b. The alias device 3108 connects to the alias switching service via the stack of user A via the telephone application 3107, through the other network stack layers as described in FIG. 1, and to the physical layer, i.e., the PSTN layer 3101 to the appropriate physical PSTN layer 3001a of the stack of the alias switching service 3008a,b and through the other layers to the telephone application layer 3007a to the alias switching service 3008a,b.

In FIG. 9, the alias switch service 3008a,b shown is comprised of an alias switch resolution 3008a and an alias switch translation 3008b. The alias switch resolution 3008a resolves an alias identifier with its appropriate information and command. The appropriate information includes an application layer address. The command can be executed or invoked by the alias switch resolution 3008a. The alias switch translation 3008b translates a message and or connection between two possibly incompatible applications. In FIG. 9, if user A 3109 attempts to connect from a telephone application 3107 to user B 3209 via user B's email application 3207a, then the alias switch translation 3008b can effect the connection between the heterogeneous networks. In FIG. 9, the alias switch translation 3008b can convert the user A 3109 telephone call sent via the telephone application 3107 to an email message receivable by user B 3209 via the email application 3207a and alias layer 3208a. If the alias switch resolution 3008a is unable to resolve the alias identifier and/or if the alias switch translation 3008b is unable to convert, then an appropriate message can be transmitted to user A 3109 to indicate no connection. In an embodiment of the present invention, the appropriate message can be transmitted by an external source.

The alias layer and the alias switching service can be used to implement multiple communication objectives, such as unified messaging, conference calls and anonymous dialing.

What is claimed is:

1. A method for a communication scheme between a plurality of applications over heterogeneous networks, comprising:
sending an alias identifier via a first application;
receiving the alias identifier by an alias mechanism,
wherein the alias identifier is associated with a command, an application identity and an application layer address, and wherein the alias identifier, the command, the application identity, and the application layer address are stored in a data storage medium,
wherein at least one of: i) the alias mechanism authenticates the alias identifier via the data storage medium, and ii) the alias mechanism executes the command associated with the alias identifier.

2. The method of claim 1, wherein the alias mechanism is at least one of an alias device and an alias switching service,
wherein the alias device attempts resolving the alias identifier via the data storage medium and if the alias identifier is resolved with at least one destination application layer address and a command, the alias device executes the command, if the destination application layer address is of a different network than the first application, then the alias device forwards the alias identifier to the alias switching service,
wherein the alias switching service executes at least one of:
i) attempts resolving at least one of the alias identifier via the data storage medium and if the alias identifier is resolved with the at least one destination application layer address and the command, the alias switching service executes the command, and
ii) attempts providing a connection between the first application and the second application.

3. The method of claim 1, wherein if the alias mechanism does one of not authenticate the alias identifier and not execute the command associated with the alias identifier, then an error indication is sent to the first application.

4. The method of claim 1, further comprising:
managing the data storage medium via a management interface to at least one of modify the data storage medium, add an additional entry to the data storage medium, and cancel the additional entry to the data storage medium.

5. The method of claim 4, further comprising:
controlling access to the data storage medium via at least one of an encryption, a permission access, and a permission authentication.

6. The method of claim 1, wherein the first application is at least one of a pager, an access terminal, a computer, a telephony device, supplementary telephony services, an error message, an interactive voice response proxy, a facsimile, a video conferencing device, a netmeeting device, an external device, a signal switching point, a PDA, SMS, and an application.

7. The method of claim 1, wherein the second application is at least one of a pager, an access terminal, a computer, a telephony device, supplementary telephony services, an error message, an interactive voice response proxy, a facsimile, a video conferencing device, a netmeeting device, an external device, a signal switching point, a PDA, SMS, and an application.

8. The method of claim 1 wherein the data storage medium is accessible and modifiable by at least one of the first and second applications via a management interface.

9. The method of claim 2, wherein the entry in the data storage medium is automatically updated by an update system via the management interface.

10. The method of claim 1, further comprising:
requiring an access code from a first application for authentication.

11. The method of claim 10, wherein the access code is at least one of a tone code, a certificate, a smart card, a voice signature, a personal identification number (PIN), a password, and a biometrics-based identification.

12. The method of claim 11, wherein the biometrics-based identification is based on at least one of a handprint, fingerprint, thumbprint, retina, skin sample, hair sample, body fluid sample, facial scan, dental scan, and dental sample.

13. The method of claim 2, wherein the alias switching service translates a message from the first application to the second application, by converting the message and the destination application layer address into an appropriate format and sending the message and the destination application layer address via an appropriate stack.

14. The method of claim 1, wherein the alias mechanism effects, depending on the command and destination application layer address associated with the alias identifier, at least one of a conference call communication, a bi-directional call communication, a multiparty call communication, a person to person call communication, a PSTN call communication, an ISDN call communication, a PLMN call communication, an IP-telephony communication, a telephony communication, a facsimile transmission, a pager communication, a message machine, a voicemail, an instant messaging service and an email communication.

15. The method of claim 2, further comprising:
directly sending the destination application layer address to the alias device.

16. The method of claim 1, wherein the data storage medium is updated with at least one of an application layer address of the first application and the destination application layer address of the second application upon authentication by an access code.

17. The method of claim 16, wherein the access code is at least one of a tone code, a certificate, a smart card, a voice signature, a personal identification number (PIN), a password, and a biometrics-based identification.

18. The method of claim 1, wherein a connection is not established unless both the first and second applications associated with the alias identifier have been authenticated.

19. The method of claim 1, wherein the management interface allows at least one of the first and second applications associated with the alias identifier to be authenticated by at least one of an access code, the application layer address of the first application and the destination application layer address.

20. The method of claim 1, wherein the command is an alert command which sends an alert to the destination application layer address an application.

21. The method of claim 1, wherein the alias identifier is associated with a plurality of commands and application layer addresses.

22. The method of claim 1, wherein at least one of the first and second applications can do at least one of modify the data storage medium, add an additional command and an additional application layer address, and change any authentication arrangement via the management interface.

23. A system for a communication scheme between at least a first application on a first network and at least a second application on a second network, comprising:
a first alias identifier;
a data storage medium; and
an alias mechanism;
wherein the alias mechanism is configured to resolve the first alias identifier via the data storage medium for an associated second application layer address and a command, the alias mechanism further configured to execute the command associated with the first alias identifier.

24. The system of claim 23, wherein the first and second networks are dissimilar.

25. The system of claim 23, where the first and second networks are similar.

26. The system of claim 23, wherein the alias mechanism is at least one of
i) an alias device; and
ii) an alias switching network,
wherein the alias device is further configured to send the first alias identifier to the alias switching network for at least one of resolving, translating and switching, when at least one of the following occurs: the first alias identifier is found invalid, the second application layer address is unknown; the second application layer address associated with the second network is dissimilar to the first network;
wherein the alias switching network is further configured to convert a communication from the first network to the second network.

27. The system of claim 26, wherein if the first alias identifier is found invalid, then the alias mechanism indicates an error.

28. The system of claim 26, wherein the data storage medium is modified via a management interface.

29. The system of claim 26, wherein access to the data storage medium requires entering an access code.

30. The system of claim 29, wherein the access code is at least one of a tone code, a certificate, a smart card, a voice signature, a personal identification number (PIN), a password, and a biometrics-based identification.

31. A method for a communication scheme between a plurality of applications over heterogeneous networks, comprising:
sending a plurality of alias identifiers via a plurality of applications;
receiving the plurality of alias identifiers by an alias mechanism;
managing the plurality of alias identifiers via the alias mechanism,
wherein each alias identifier of the plurality of alias identifiers is associated with at least one command, at least one application and at least one application layer address,
wherein each alias identifier of the plurality of alias identifiers, the at least one command, the at least one application and the at least one application layer address are stored in a data storage medium,
wherein at least one of: i) the alias mechanism authenticates each alias identifier of the plurality of alias identifiers via the data storage medium, and ii) the alias mechanism executes the at least one command associated with each alias identifier of the plurality of alias identifiers, and
wherein each alias identifier of the plurality of alias identifiers is managed via the alias mechanism by a single entity so that the single entity determines the at least one command, the at least one application and the at least one application layer address associated with each alias identifier of the plurality of alias identifiers.

32. A method for a communication scheme between a plurality of applications over heterogeneous networks, comprising:
sending a first alias identifier via a first application;
receiving the first alias identifier by an alias mechanism;
sending a second identifier via a second application;
receiving the second alias identifier by the alias mechanism,
wherein the first alias identifier is associated with a first command, a first application identity and a first application layer address, and wherein the first alias identifier, the first command, the first application identity, and the first application layer address are stored in a data storage medium,
wherein the second alias identifier is associated with a second command, a second application identity and a second application layer address, and wherein the second alias identifier, the second command, the second application identity, and the second application layer address are stored in the data storage medium,
wherein at least one of: i) the alias mechanism authenticates the first alias identifier via the data storage medium, ii) the alias mechanism executes the first command associated with the first alias identifier, iii) the alias mechanism authenticates the second alias identifier via the data storage medium, iv) the alias mechanism executes the second command associated with the first alias identifier, and v) the alias mechanism effects the first and second commands after the first and second alias identifiers are received and authenticated by the alias mechanism.

33. A method for a communication scheme between a plurality of applications over heterogeneous networks, comprising:
sending a first alias identifier and a first access mechanism via a first application;
receiving the first alias identifier and the first access mechanism by an alias mechanism;
sending the first identifier and a second access mechanism via a second application;
receiving the first alias identifier and the second access mechanism by the alias mechanism,
wherein the first alias identifier and the first access mechanism are associated with a first command, a first application identity and a first application layer address, and wherein the first alias identifier, the first access mechanism, the first command, the first application identity, and the first application layer address are stored in a data storage medium,
wherein the first alias identifier and the second access mechanism are associated with a second command, a second application identity and a second application layer address, and wherein the first alias identifier and the second access mechanism, the second command, the second application identity, and the second application layer address are stored in the data storage medium,
wherein at least one of: i) the alias mechanism authenticates the first alias identifier and the first access mechanism via the data storage medium, ii) the alias mechanism executes the first command associated with the first alias identifier, iii) the alias mechanism authenticates the first alias identifier and the second access mechanism via the data storage medium, iv) the alias mechanism executes the second command associated with the first alias identifier and the second access mechanism, and v) the alias mechanism effects the first and second commands after the first identifier and the first and second access mechanisms are received and authenticated by the alias mechanism.

34. The method of claim 33, wherein the first and second access mechanisms are at least one of a tone code, a certificate, a smart card, a voice signature, a personal identification number (PIN), a password, and a biometrics-based identification.
